(19) United States
(12) Patent Application Publication
(10) Pub. No.: US 2017/0023792 A1
(43) Pub. Date: Jan. 26, 2017

(54) DIFFERENTIATED VIEWING DEVICE PROVIDED WITH ACTIVE SPECTACLES

(71) Applicant: Valeo Vision, Bobigny Cedex (FR)

(72) Inventors: Hafid El Idrissi, Pantin (FR); Kostadin Beev, Emerainville (FR); David Hue, Butry Sur Oise (FR); Steed Gratien, Pontault Combault (FR)

(21) Appl. No.: 15/214,797

(22) Filed: Jul. 20, 2016

(30) Foreign Application Priority Data
Jul. 23, 2015 (FR) 1556980

(51) Int. Cl. G02B 27/01

(52) U.S. Cl. CPC G02B 27/0172; G02B 2027/0178

(57) ABSTRACT

A differentiated viewing device, notably for a motor vehicle, comprising a light system configured to selectively emit first and second light signals, the device further comprises a first pair of active spectacles intended to be worn by a first observer, the first pair of spectacles being provided with a first screen capable of allowing the vision of the first observer in a first configuration and of blanking the vision of the first observer in a second configuration, the light system and the first pair of spectacles being synchronized so that the first screen is in the first configuration when the light system emits the first signals, and in the second configuration when the light system emits the second signals.

### CROSS-REFERENCE TO RELATED APPLICATIONS

This application claims priority to the French application 1556980 filed Jul. 23, 2015, which applications are incorporated herein by reference and made a part hereof.

### BACKGROUND OF THE INVENTION

1. Field of the Invention

The present invention relates to a differentiated viewing device provided with active spectacles.

2. Description of the Related Art

In a same location, several people may want to see or observe different light signals although they are in a same room or are watching a same display.

Thus, it is for example possible to want a uniform lighting for each person in order to feel a different light ambience, whether in intensity or in color. More particularly, in a vehicle interior, the driver and the passenger often need a lighting suited to each, the driver generally requiring a lower lighting intensity level than the passenger. In effect, the passenger generally performs activities independent of the driving, such as reading, whereas the driver prefers not to be hampered by intense lighting to watch the road.

These days, there is no system which allows two people situated in a same place, to perceive a different lighting, notably from a same light source.

In the display field, efforts have also been made to display distinct data which can be viewed by two different observers independently with a single display. There are notably displays capable of simultaneously displaying data, such as images or information, intended for two different observers, each observer seeing only the information intended for him or her. In other words, the display is designed to allow certain information to be seen by one observer and other information to be seen by another observer, without them being able to see the information intended for the other observer.

An example of operation of such a display is based on an interleaving of two images which are displayed simultaneously. The two images are subdivided into thin vertical strips and arranged alternately. Depending on the position of the observer, and therefore his or her point of view, he or she sees one or other of the images by the reconstruction thereof. A possible application of these systems is for example in a vehicle, the display being arranged in the middle of the dashboard between the driver and the passenger so that the driver and the passenger have different viewing angles for the same display. Thus, the driver can see information linked to navigation while the passenger watches a film.

However, the drawback of such a display lies on the one hand in the fact that the observer must retain the viewing angle corresponding to the image that he or she wants to view. Thus, an observer situated in the axis of the display observes the interleaving of the two images. On the other hand, the display must be wide enough to display adequate image sizes, which means a display width two times greater for a same image size.

### SUMMARY OF THE INVENTION

The invention therefore aims to obtain a differentiated viewing device which improves the situation and avoids the abovementioned defects, and which makes it possible on the one hand to perceive a different lighting in a same place, or to obtain a display of at least two different images on a same display for at least two observers.

To this end, the invention relates to a differentiated viewing device, notably for a motor vehicle, comprising a light system configured to selectively emit first and second light signals, the device further comprises a first pair of active spectacles intended to be worn by a first observer, the first pair of spectacles being provided with a first screen capable of allowing the vision of the first observer in a first configuration and of blanking the vision of the first observer in a second configuration, the light system and the first pair of spectacles being synchronized so that the first screen is in the first configuration when the light system emits the first signals, and in the second configuration when the light system emits the second signals.

Thus, it is sufficient for an observer to wear the active spectacles to see only the light signals which are intended for him or her, without being hampered by other light signals emitted by the light system. The device further makes it possible to use a single light system to selectively emit two different signals intended for two different observers.

This device works equally well for a lighting system and for a screen which displays information intended for different people. In effect, in the case of a lighting system, the observer perceives only the lighting of the first light signals. And in the case of a data display, the observer sees on the screen only the first signals.

According to different embodiments of the invention, which will be able to be taken together or separately:
the device comprises a second pair of active spectacles intended to be worn by a second observer, the second pair of spectacles being provided with a second screen, the light system and the second pair of spectacles being synchronized so that the second screen is in the first configuration when the light system emits the second signals, and in the second configuration when the light system emits the first signals,
in the first configuration, the first screen and/or the second screen is configured to allow light rays to pass through it,
in the first configuration, the first screen and/or the second screen is substantially transparent,
in the second configuration, the first screen and/or the second screen is configured to prevent light rays from passing through it,
in the second configuration, the first screen and/or the second screen blanks by absorption of the light rays,
in the second configuration, the first screen and/or the second screen blanks by reflection of the light rays,
the light system is configured to alternately present the first and second signals,
the first and second signals are distinct signals,
the first signals convey first information and the second signals convey second information, the first information and the second information being mutually decorrelated,
the light system comprises a display, the light signals being data that can be displayed on the display,
the display is a head-up display,
the light system comprises light elements of a dashboard of a vehicle, the light signals being emitted by these light elements,
the light system comprises a vehicle interior lighting device, the light signals being emitted by this lighting device so as to light up the interior,
the light system is configured to emit the light signals by pulse width modulation,
the first pair of spectacles is arranged to control the switching of the first screen between the first and second configurations by pulse width modulation,
the second pair of spectacles is arranged to control the switching of the second screen between the first configuration and the second configuration by pulse width modulation,
the light system is configured to emit the first light signals according to a first pulse width modulation and the second signals according to a second pulse width modulation,
the first and second modulations are phase-shifted relative to one another. If appropriate, the first and second modulations can be in phase opposition,
the duty cycles of the first and second modulations are identical,
the duty cycles of the first and second modulations are distinct,
the modulation is performed at fixed frequency,
the modulation frequency is higher than 120 Hz, preferably higher than 200 Hz,
the pulse width modulation controlling the switching of the first screen is synchronized with the pulse width modulation of the first light signals,
the pulse width modulation controlling the switching of the second screen is synchronized with the pulse width modulation of the second light signals,
the duty cycles and the phases of the modulations are identical,
the first screen and/or the second screen is provided with a vertical polarization layer and a horizontal polarization layer,
the first screen and/or the second screen is provided with a liquid crystal layer arranged between the two polarization layers,
the actuation of the liquid crystal layer makes it possible to render the screen substantially blanking or substantially transparent,
the light system comprises signal generation means configured to transmit the first and second signals to the display.

The invention relates also to a light system configured to alternately emit first and second light signals synchronized with at least one pair of active spectacles.

The invention relates also to a pair of active spectacles for such a differentiated viewing device.

These and other objects and advantages of the invention will be apparent from the following description, the accompanying drawings and the appended claims.

### BRIEF DESCRIPTION OF THE ACCOMPANYING DRAWINGS

The invention will be better understood in light of the following description which is given in a purely indicative and nonlimiting manner, accompanied by the attached drawings in which:

FIG. 1 schematically illustrates the operation of a viewing device in a first embodiment with a display device; and

FIG. 2 schematically illustrates the operation of a viewing device in a second embodiment with a lighting system.

### DETAILED DESCRIPTION OF THE PREFERRED EMBODIMENTS

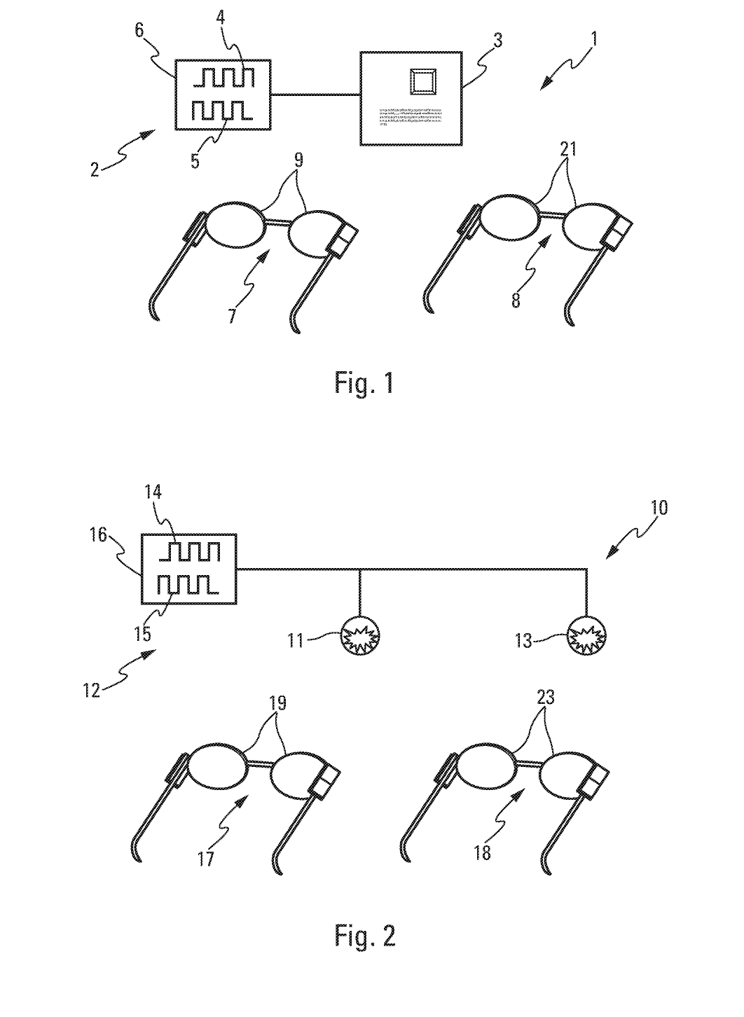

FIG. 1 shows a first embodiment of a differentiated viewing device 1, notably for a motor vehicle. The device 1 comprises a light system 2 provided with a data display 3, for example a liquid crystal display of LCD type. The display 3 is, for example, arranged on the dashboard of the vehicle, not represented in the figures, between the place for the driver and that for the passenger so as to be able to be seen by two people seated in the places. In a variant embodiment, the light system 2 is a head-up display, of HUD type.

The display 3 is configured to selectively emit first and second light signals 4, 5. In other words, the display 3 successively presents first light signals 4, which are for example navigation data or vehicle status data, and second light signals 5, which are for example linked to the display of an entertainment video. The first light signals 4 are intended for the driver of the vehicle, and the second signals 5 are intended to be seen by a passenger of the vehicle.

For that, the light system 2 comprises means 6 for generating signals configured to transmit to the display the first and the second light signals 4, 5. Thus, when the generation means 6 transmit the first signals 4, the first light signals 4 appear on the display 3, and when the generation means 6 transmit the second light signals 5, the second light signals 5 appear on the display 3. The first and second light signals 4, 5 are here distinct signals. For example, the first light signals 4 convey first information and the second light signals 5 convey second information, the first information and the second information being mutually decorrelated.

The generation means 6 are, preferably, configured to transmit the first and the second light signals 4, 5 by pulse width modulation. The modulation consists in periodically displaying a light signal for a time t1, and in not displaying them for a time t2, the times t1 and t2 forming the period of the modulation of the light signal. The modulation is performed at a fixed frequency, preferably at least 100 Hz, even at least 125 Hz, and preferably at least 200 Hz to have optimal comfort of visibility by the human eye without perceiving the modulation. Preferably, the light system 2 is configured to emit the first light signals 4 according to a first pulse width modulation and the second light signals 5 according to a second pulse width modulation.

Furthermore, the light system 2 is configured to alternately emit the first and the second light signals 4, 5, for the two passengers to each perceive the first and second light signals 4, 5 which is intended for him or her, and thus watch the display 3 at the same time. For example, during the time t1, the display 3 displays only the first light signals 4 on the display 3, and during the time t2, it displays only the second light signals 5, the times t1 and t2 forming the period of the same modulation. The modulation of the first and second light signals 4, 5 is in phase opposition. The alternating modulation gives the two observers the perception of watching the first and the second light signals 4, 5 at the same time.

For the driver to observe only the first light signals 4, the device 1 comprises a first pair of active spectacles 7 intended to be worn by a first observer, here the driver. The device 1 also comprises a second pair of active spectacles 8 intended to be worn by a second observer, here the passenger. The first and second pair of active spectacles 7, 8 are configured to selectively allow or prevent the vision of the wearer of the first and second pair of active spectacles 7, 8.

To this end, the first pair of active spectacles 7 is provided with a first screen 9 and the second pair of active spectacles 8 with a second screen 21. Each first and second screen 9, 21 is capable, in a first configuration, of allowing the vision of the first observer, and in a second configuration, of blanking the vision of the first observer. In the first configuration, the first screen 9 is substantially transparent and transmits the incident light intended for the first observer, whereas, in the second configuration, the second screen 21 is substantially blanking and does not transmit the incident light intended for the first observer. In other words, in the first configuration, the wearer of the first pair of active spectacles 7 sees through, and in the second configuration, he or she does not see. In the first configuration, the first screen 9 and/or the second screen 21 is configured to allow light rays to pass through it. For example, the first screen 9 and/or the second screen 21 is substantially transparent. In the second configuration, the first screen 9 and/or the second screen 21 is configured to prevent light rays from passing through it, for example by being blanking by absorption of the light rays.

The first screen 9 and the second screen 21 are, for example, provided with a vertical polarization layer, a horizontal polarization layer, and a liquid crystal layer arranged between the two polarization layers. The actuation of the liquid crystal layer makes it possible to render the first screen 9 and second screen 21 substantially blanking or substantially transparent. The operation of such a pair of spectacles is described in the patent application FR 2988493, which is equivalent to U.S. Publication No. 2015/0062469.

According to the invention, the light system 2 and the first pair of active spectacles 7 are synchronized so that the first screen 9 is in the first configuration (screen transparent), when the light system 2 emits the first light signals 4, and in the second configuration (screen blanking) when the light system 2 emits the second light signals 5. Thus, when the display 3 displays the first light signals 4, the driver can see them, and when the display 3 displays the second light signals 5, the driver cannot see them.

Similarly, the light system 2 and the second pair of active spectacles 8 are synchronized so that the second screen 21 allows the vision of the passenger, when the light system 2 emits the second light signals 5, and blanks the vision of the passenger when the light system 2 emits the first light signals 4. Thus, when the display 3 displays the first light signals 4, the passenger cannot see them, and when the display 3 displays the second light signals 5, the passenger can see them.

Thus, as for the emission of the first and second light signals 4, 5, the first screen 9 of the first pair of active spectacles 7 and the second screen 21 of the second pair of active spectacles 8, are each either in the first configuration, or in the second configuration by pulse width modulation. A screen 9, 21 is alternately in the first configuration, then in the second configuration, and this occurs periodically. The modulation frequencies of the two screens 9, 21 are synchronized with the modulation frequencies of the first and second light signals 4, 5 intended for the display 3.

The first pair of active spectacles 7 is arranged to control the switching of the first screen 9 between the first configuration and the second configuration by pulse width modulation. Similarly, the second pair of active spectacles 8 is arranged to control the switching of the second screen 21 between the first configuration and the second configuration by pulse width modulation. The pulse width modulation controlling the switching of the first screen 9 is synchronized with the pulse width modulation of the first light signals 4. Similarly, the pulse width modulation controlling the switching of the second screen 21 is synchronized with the pulse width modulation of the second light signals 5.

Preferably, the first screen 9 is in phase with the modulation period of the first light signals 4, and the second screen 21 is in phase with the modulation period of the second light signals 5. Thus, during the time t1, the first screen 9 of the first pair of active spectacles 7 is in the first configuration, and the second screen 21 of the second pair of active spectacles 8 is in the second configuration. And, during the time t2, the first screen 9 of the first pair of active spectacles 7 is in the second configuration, and the second screen 21 of the second pair of active spectacles 8 is in the first configuration. The first screen 9 and the second screen 21 are modulated at the same frequency in phase opposition. By virtue of the first and second pair of active spectacles 7, 8, the driver sees only the first light signals 4, and the passenger sees only the second light signals 5.

In a variant embodiment, the first and/or the second light signals 4, 5 are signals intended to be seen in three dimensions. The first and second light signals 4, 5 displayed consequently have different components for each eye of the same observer. To see them, the first and second pair of active spectacles 7, 8 have a glass screen 9, 21, the screens 9, 21 of a particular pair of active spectacles 7, 8 being configured to be alternately in the first configuration and the second configuration. Thus, the screens 9, 21 of a particular pair of active spectacles 7, 8 are, on the one hand, configured to be simultaneously in the second configuration, when the first and second light signals 4, 5 displayed are not intended for the wearer of the first and second pair of active spectacles 7, 8, and, on the other hand, configured to be alternately in the first configuration between them, when the components of a same light signal 4, 5 are displayed, and therefore intended for the same wearer of the first and second pair of active spectacles 7, 8.

In a second embodiment, represented in FIG. 2, the differentiated viewing device 10 comprises a lighting device as light system 12, notably of a motor vehicle interior. The light system 12 here comprises two lighting means, for example two lamps 11, 13 of different intensity or color. The first light signals 14 are here emitted by a first lamp 11 and the second light signals 15 by a second lamp 13. The lamps 11, 13 are controlled by a control unit 16.

This lighting device or system 12 is used here to light up the interior differently for the driver and the passenger, without one perceiving the lighting intended for the other. As in the first embodiment, the first lamp 11 is synchronized at a modulation frequency with a first pair of spectacles 17 provided with a first screen 19, and the second lamp 13 is synchronized, at the same modulation frequency, with the second pair of spectacles 18 provided with a second screen 23. The first and second pairs of spectacles 17, 18 operate identically to those of the first embodiment. By virtue of the invention, the driver and the passenger perceive two different lightings, one corresponding to that of the first lamp 11, and the other to that of the second lamp 13.

In a third embodiment, not represented in the figures, the light system comprises light elements of a vehicle dashboard, the light signals being emitted by these light elements. The light elements are for example arranged on the buttons of the dashboard. The differentiated viewing device operates as in the first embodiment or the second embodiment. Thus, the driver and the passenger see only the lighting of the light buttons which are intended for them, for example those they want to use.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A differentiated viewing device, notably for a motor vehicle, comprising a light system configured to selectively emit first and second light signals, said differentiated viewing device further comprises a first pair of active spectacles intended to be worn by a first observer, said first pair of active spectacles being provided with a first screen capable of allowing the vision of said first observer in a first configuration and of blanking the vision of said first observer in a second configuration, said light system and said first pair of active spectacles being synchronized so that said first screen is in said first configuration when said light system emits said first light signals, and in said second configuration when said light system emits said second light signals.

2. The differentiated viewing device according to claim 1, comprising a second pair of active spectacles intended to be worn by a second observer, said second pair of active spectacles being provided with a second screen said light system and said second pair of active spectacles being synchronized so that said second screen is in said first configuration when said light system emits said second light signals, and in said second configuration when said light system emits said first light signals.

3. The differentiated viewing device according to claim 1, in which said light system comprises a display, said first and second light signals being data that can be displayed on said display.

4. The differentiated viewing device according to claim 3, in which said display comprises a head-up display.

5. The differentiated viewing device according to claim 1, in which said light system comprises light elements of a dashboard of a vehicle, said first and second light signals being emitted by said light elements.

6. The differentiated viewing device according to claim 1, in which said light system comprises a vehicle interior lighting device, said first and second light signals being emitted by said vehicle lighting device so as to light up the interior.

7. The differentiated viewing device according to claim 1, in which said light system is configured to alternately emit said first light signal and said second light signal.

8. The differentiated viewing device according to claim 1, in which said light system is configured to emit said first and second light signals by pulse width modulation.

9. The differentiated viewing device according to claim 1, in which said first pair of active spectacles is arranged to control a switching of said first screen between said first and second configurations by pulse width modulation.

10. The differentiated viewing device according to claim 8, in which said pulse width modulation is performed at fixed modulation frequency.

11. The differentiated viewing device according to claim 10, in which said modulation frequency is higher than 120 Hz, preferably higher than 200 Hz.

12. The differentiated viewing device according to claim 1, in which said first screen and/or said second screen is provided with a vertical polarization layer and a horizontal polarization layer.

13. The differentiated viewing device according to claim 12, in which said first screen and/or said second screen is provided with a liquid crystal layer arranged between said vertical and horizontal polarization layers.

14. A light system for the differentiated viewing device according to claim 1, said light system being configured to alternately emit said first and second light signals synchronized with at least one pair of said first and second pair of active spectacles.

15. A pair of active spectacles for said differentiated viewing device according to claim 1.

16. The differentiated viewing device according to claim 2, in which said light system comprises a display, said first and second light signals being data that can be displayed on said display.

17. The differentiated viewing device according to claim 2, in which said first pair of active spectacles is arranged to control a switching of said first screen between said first and second configurations by pulse width modulation.

18. The differentiated viewing device according to claim 9, in which said pulse width modulation is performed at fixed modulation frequency.

19. The differentiated viewing device according to claim 2, in which said first screen and/or said second screen is provided with a vertical polarization layer and a horizontal polarization layer.

20. A light system for the differentiated viewing device according to claim 2, said light system being configured to alternately emit said first and second light signals synchronized with at least one pair of said first and second pair of active spectacles.
